(19) United States
(12) Patent Application Publication
(10) Pub. No.: US 2025/0306987 A1
(43) Pub. Date: Oct. 2, 2025

(54) PARALLEL AND DISTRIBUTED TOPOLOGICAL SORTING FOR SCHEDULING PROCESSING TASKS

(71) Applicant: NVIDIA Corporation, Santa Clara, CA (US)

(72) Inventor: Oded GREEN, Rosewell, GA (US)

(73) Assignee: NVIDIA Corporation, Santa Clara, CA (US)

(21) Appl. No.: 18/619,880

(22) Filed: Mar. 28, 2024

(51) Int. Cl. G06F 9/48; G06F 9/52

(52) U.S. Cl. CPC G06F 9/4881; G06F 9/52

(57) ABSTRACT

In various examples, systems and methods are disclosed that relate to the implementation of parallel and distributed topological sorting. For example, a system can receive data associated with a request, the request associated with a plurality of dependencies. In an example, the plurality of dependencies can include a first dependency and a second dependency, and the system can determine that a first dependency of the set of dependencies is satisfied. In examples, the system can cause an indication to be provided that the first dependency is satisfied to a system associated with the second dependency.

### BACKGROUND

Topological sorting can be implemented to improve certain computational tasks, such as scheduling tasks and jobs, compiling and linking programs, and so on. In the context of scheduling tasks, when scheduling across multiple systems (e.g., software modules, distinct computing components, distinct computing devices, and/or the like) schedules are carefully created to avoid computing errors. For example, when installing a program, execution of the program may be predicated on successfully obtaining and installing multiple packages. Like the program, each package may be further predicated on successfully obtaining and installing other packages, and so on. But the implementation of topological sorting for tasks such as scheduling can become increasingly difficult, particularly in distributed computing environments.

### SUMMARY

Embodiments of the present disclosure relate to parallel and distributed topological sorting. In contrast with conventional systems, such as those described above, the systems and methods described herein implement topological sorting so as to overcome the limitations inherent to conventional scheduling techniques implemented by, among other things, package managers. For example, devices within a distributed computing environment that would otherwise wait for a signal from a package manager before proceeding with package installations may independently determine that such devices can proceed based at least on receiving indications that corresponding dependencies are satisfied by other devices in the distributed computing environment. Further, each of the devices involved are no longer limited by the speed and efficiency of a device or system coordinating operations within the distributed computing environment (e.g., a package manager hosted by a device in the distributed computing environment and/or the like). As such, the distributed environment can scale in complexity without a corresponding increase in probability that devices will unnecessarily operate in idle states as unreachable devices perform operations unrelated to a given device.

At least one aspect relates to one or more processors. The one or more processors can include one or more circuits to receive data associated with a request to perform one or more processing operations using a graphics processing unit (GPU) comprising a plurality of cores, the request associated with a plurality of dependencies comprising a first dependency and a second dependency; cause the plurality of cores involved in processing the request to perform the one or more processing operations in parallel based at least in part on a topological ordering associated with the processing operations; determine that a first dependency of the set of dependencies is satisfied by a core of the plurality of cores in the GPU; and cause the core associated with the first dependency to provide an indication that the first dependency is satisfied to a core associated with a second dependency. In some implementations, when determining the first dependency is satisfied, the one or more circuits are to determine that one or more operations associated with the first dependency were executed by the one or more circuits, and that execution of the one or more operations was successful.

In some implementations, one or more circuits are to: determine that a precondition associated with the second dependency is not satisfied; and forgo satisfying the second dependency based at least on determining that the precondition associated with the second dependency is not satisfied. In some implementations, the precondition associated with the second dependency is further associated with satisfaction of the first dependency and a third dependency.

In some implementations, the one or more circuits are to: receive an indication that a third dependency is satisfied after forgoing satisfying the second dependency; determine that the precondition associated with the second dependency is satisfied based on receiving the indication that the third dependency is satisfied; and execute one or more operations associated with the second dependency based at least on determining that the precondition associated with the second dependency is satisfied. In some implementations, when receiving the indication that the third dependency is satisfied, the one or more circuits are to: receive the indication that the third dependency is satisfied from a core that is the same as the core corresponding to the second dependency. In some implementations, when receiving the indication that the third dependency is satisfied, the one or more circuits are to: receive the indication that the third dependency is satisfied from a core that is different from the core corresponding to the second dependency.

In some implementations, the one or more circuits are to: communicate each indication to respective cores in accordance with a predetermined network architecture. In some implementations, the predetermined network architecture is associated with a butterfly network.

In some implementations, the second dependency is a precondition to the request. In some implementations, the one or more circuits are to: determine that the plurality of dependencies associated with the request are satisfied based at least on executing the one or more operations associated with the second dependency; and satisfy the request based at least on determining that the plurality of dependencies associated with the request are satisfied.

In some implementations, the one or more processors is comprised in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system implementing large language models (LLMs); a system implementing vision language models (VLMs); a system for hosting one or more real-time streaming applications; a system for performing light transport simulation; a system for performing collaborative content creation for 3D assets; or a system implemented at least partially using cloud computing resources.

At least one aspect relates to a system. The system can include one or more processors to perform operations comprising: receiving data associated with a request to perform one or more processing operations, the request associated with a plurality of dependencies, the plurality of dependencies comprising a first dependency and a second dependency; causing a plurality of systems in a distributed computing environment involved in processing the request to perform the one or more processing operations in parallel based at least in part on a topological ordering associated with the processing operations; determining that a first dependency of the set of dependencies is satisfied by a system of the plurality of systems in the distributed computing environment; and causing the system associated with the first dependency to provide an indication that the first dependency is satisfied to a system associated with a second dependency. In some implementations, when determining that the first dependency is satisfied, the one or more processors perform the operation of: determining that one or more operations associated with the first dependency were executed by the one or more processors, and that the execution of the one or more operations was successful.

In some implementations, the one or more processors perform the operation of: determining that a precondition associated with the second dependency is not satisfied; and forgoing satisfying the second dependency based at least on determining that the precondition associated with the second dependency is not satisfied. In some implementations, the precondition associated with the second dependency is further associated with satisfaction of the first dependency and a third dependency.

In some implementations, the one or more processors perform the operations of: receiving an indication that a third dependency is satisfied after forgoing satisfying the second dependency; determining that the precondition associated with the second dependency is satisfied based on receiving the indication that the third dependency is satisfied; and executing one or more operations associated with the second dependency based at least on determining that the precondition associated with the second dependency is satisfied.

In some implementations, when receiving the indication that the third dependency is satisfied, the one or more processors perform the operation of: receiving the indication that the third dependency is satisfied from a system that is the same as the system corresponding to the second dependency. In some implementations, when receiving the indication that the third dependency is satisfied, wherein the one or more processors perform the operation of: receiving the indication that the third dependency is satisfied from a system that is different from the system corresponding to the second dependency.

In some implementations, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system for generating synthetic data; a system incorporating one or more virtual machines (VMs); a system implemented at least partially in a data center; or a system implemented at least partially using cloud computing resources.

At least one aspect relates to a method. The method can include receiving data associated with a request to perform one or more processing operations, the request associated with a plurality of dependencies, the plurality of dependencies comprising a first dependency and a second dependency; causing a plurality of systems in a distributed computing environment involved in processing the request to perform the one or more processing operations in parallel based at least in part on a topological ordering associated with the processing operations; determining that a first dependency of the set of dependencies is satisfied by a system of the plurality of systems in the distributed computing environment; and causing the system associated with the first dependency to provide an indication that the first dependency is satisfied to a system associated with a second dependency.

### BRIEF DESCRIPTION OF THE DRAWINGS

The present systems and methods for parallel and distributed topological sorting are described in detail below with reference to the attached drawing figures, wherein:

FIG. 1 is a block diagram of an example environment for implementing parallel and distributed topological sorting, in accordance with some embodiments of the present disclosure;

FIG. 2 is a block diagram of assignment of devices of FIG. 1 to graphics processing units, in accordance with some embodiments of the present disclosure;

FIG. 3 is a is a flow diagram of an example method implementing parallel and distributed topological sorting, in accordance with some embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

Systems and methods are disclosed related to parallel and distributed topological sorting. It will be understood that, although various implementations are described in association with the implementation of parallel and distributed topological sorting as they relate to the scheduling of package installation across systems in a distributed computing environment, the systems and methods described herein can be applied to a variety of other domains, along with the techniques they implement. These domains can include those associated with scheduling processes to be executed by a central processing unit (CPU), scheduling processes to be executed by a graphics processing unit (GPU) (e.g., scheduling processes to be executed across cores of a GPU), and/or the like.

With continued reference to scheduling during package installation, complex package managers can be implemented to keep track of a software installation request(s), the corresponding packages needed to satisfy the installation request(s), and in some cases additional packages required (but not identified) to satisfy the installation request(s). For example, package managers can use topological sorting techniques to build a dependency graph. This dependency graph can then be used to generate a linear ordering of the packages to be installed. Once the graph is complete, the package manager orchestrates the installation of the packages, causing the packages to be installed based at least on the linear ordering required by their dependencies.

But while package managers can be useful when managing processes (e.g., installations) across systems in individual computing devices, the use of conventional package managers in distributed computing environments (e.g., environments including multiple computing devices, environments including multiple processing devices such as GPUs with multiple cores, and/or the like) can be inefficient at scale. First, additional coordination is needed among the devices in the distributed computing environment to ensure each device has the information it needs to proceed in view of the progression of the other devices in the environment. This, in turn, increases the amount of communication performed between the systems and devices in the environment and the package manager. Second, each of the systems involved are limited by the speed and efficiency of the system or device hosting the package manager. As a result, as devices scale in complexity and as more devices are added to a distributed computing environment, the likelihood that devices will unnecessarily operate in idle states likewise increases.

In some embodiments, the systems and methods described herein can use topological sorting to arrange the performance of tasks in parallel within a distributed environment. In one example, a system can include one or more processors that include one or more circuits to receive data associated with a request, the request associated with a plurality of dependencies; determine that a first dependency of the set of dependencies is satisfied; and cause a system associated with the first dependency to provide an indication that the first dependency is satisfied to a system associated with a second dependency. This process may be performed iteratively until all dependencies are resolved.

By implementing systems and methods in accordance with the techniques described herein, the use of topological sorting in a distributed environment can be scaled as a given distributed environment increases in size and complexity. For example, in the context of program installation, packages can be installed across different devices (e.g., different processors, different computing devices, and/or the like) within a distributed environment without the need for constant oversight by a package manager, thereby eliminating a potential bottleneck. And in the context of scheduling, task execution can be determined based at least on each device involved in a given distributed environment further determining that one or more of the dependencies associated with a given task (e.g., operation) are satisfied, reducing and/or eliminating the need for a centralized scheduler. These improvements can increase the efficiency of the systems in a distributed environment by eliminating the above-noted bottlenecks and improve overall system uptime and efficiency.

The systems and methods described herein may be used for a variety of purposes, by way of example and without limitation, for program installation, program compilation, image processing, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

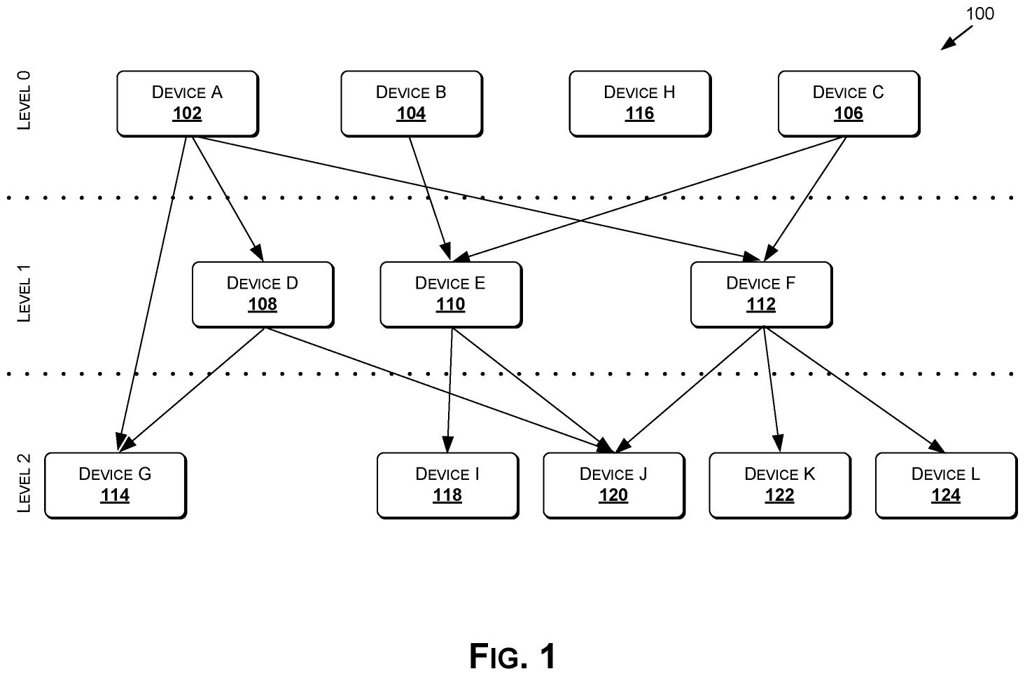

With reference to FIG. 1, FIG. 1 is an example computing environment 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

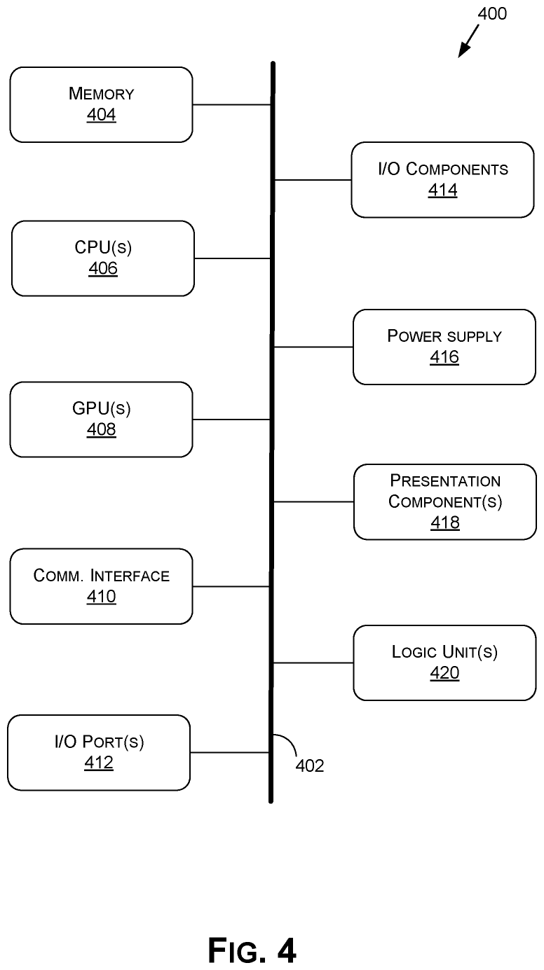

The computing environment 100 includes a plurality of devices 102-124. In some embodiments, the plurality of devices (sometimes referred to as “systems”) can include, for example, computing devices that are the same as, or similar to, the computing device 400 of FIG. 4. For example, a distributed computing environment can include the plurality of devices 102-124, where each device corresponds to a computing device that is in communication with one or more other computing devices via one or more networks as described herein. Additionally, or alternatively, the plurality of devices can include, for example, one or more corresponding system on a chip (SoC) devices. For example, the plurality of devices can include one or more corresponding SoCs that integrate multiple components like processors, memory, and peripherals into a single piece of silicon.

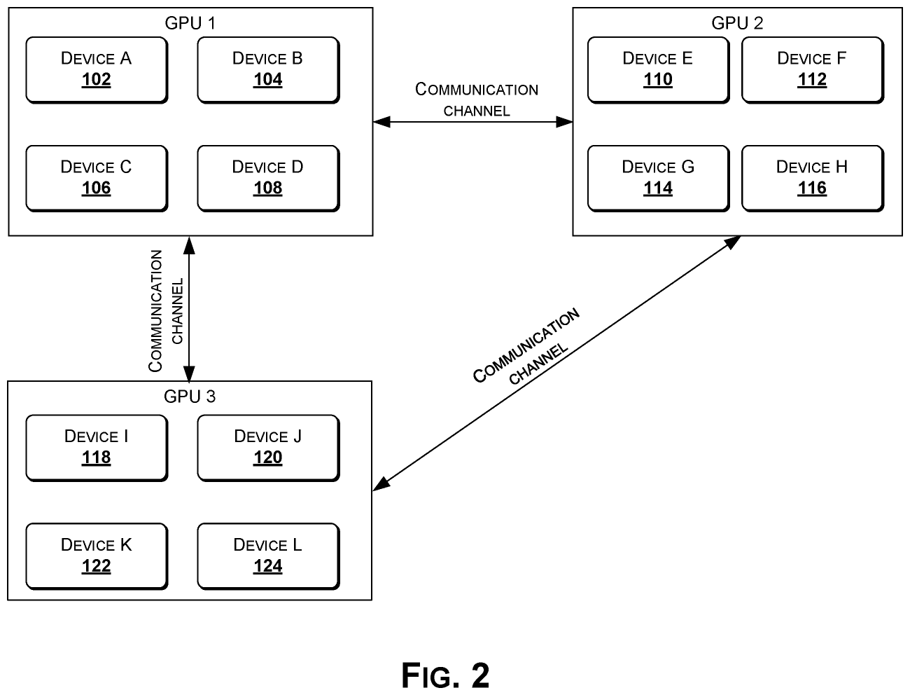

In some embodiments, some and/or all of the plurality of devices 102-124 can include processors within a computing device. For example, the plurality of devices 102-124 can be included in a graphics processing unit (GPU). In this example, the plurality of devices 102-124 can include one or more of: streaming multiprocessors (SMs), streaming processors (SPs) within a given SM, tensor cores, hardware accelerators, and/or the like. In examples, some and/or all of the plurality of devices 102-124 can include processors within a multi-core processor. In this example, some and/or all of the plurality of devices 102-124 can include individual cores or groups of cores within the multi-core processor. In some embodiments, some and/or all of the plurality of devices 102-124 can be associated with (e.g., assigned to) one or more GPUs. In one illustrative example, as shown in FIG. 2, each device can be assigned to (e.g., implemented by and/or the like) either GPU 1, GPU 2, or GPU 3. As described herein, each GPU can be configured to communicate with one or more other GPUs via communication channels (e.g., communication channels that are the same as, or similar to, peripheral component interconnect express (PCIe), Nvidia's NVlink, and/or the like) to enable communication between each device of the plurality of devices 102-124.

In some embodiments, some and/or all of the plurality of devices 102-124 can include processors within a computing device that is virtual. For instance, one or more of the examples described herein with respect to the plurality of devices 102-124 can be simulated in a virtual environment (e.g., by a desktop, server, a group of desktops and/or servers, and/or the like). In these examples, the plurality of devices 102-124 can perform operations (sometimes referred to as processing operations) in accordance with the techniques described herein when simulated in the virtual environment.

In some embodiments, some and/or all of the plurality of devices 102-124 can include modules (sometimes referred to as software modules) implemented by computing devices that are physical and/or virtual. For example, one or more of the examples described herein with respect to the plurality of devices 102-124 can be implemented based at least on execution of one or more software modules, where each of the one or more software modules corresponds to a device of the plurality of devices 102-124. In this example, the plurality of devices 102-124 can perform operations in accordance with the techniques described herein based at least on the execution of the one or more software modules.

In some embodiments, one or more of the plurality of devices 102-124 can be configured to communicate with one or more other devices of the plurality of devices 102-124 in accordance with a network type. For example, one or more of the plurality of devices 102-124 can communicate with one or more other devices of the plurality of devices 102-124 based at least on (e.g., using) a one-to-many network. In this example, each device of the plurality of devices 102-124 can communicate with each other device of the plurality of devices 102-124 in accordance with the one-to-many network to perform one or more of the operations described herein. Some non-limiting examples of operations can include installing packages during installation of a program (e.g., acquiring and setting up software components that a given program relies on to function), compiling portions of a program (e.g., translating sections of source code into machine-readable code (sometimes referred to as bytecode)), and/or the like. In another example, one or more of the plurality of devices 102-124 can be configured to communicate with one or more other devices of the plurality of devices 102-124 based at least on a butterfly network. In this example, each device of the plurality of devices 102-124 can communicate with a set of devices of the plurality of devices 102-124 in accordance with the butterfly network to perform one or more of the operations described herein. In one illustrative example, each device of the plurality of devices 102-124 can be associated with a plurality of stages. At each stage, each device of the plurality of devices 102-124 can be associated with a switching element that connects the device with a different device of the plurality of devices 102-124. These switching elements can cause data to be transmitted between the plurality of devices 102-124 in accordance with one or more predefined patterns (e.g., patterns associated with all-to-all networks, patterns associated with butterfly networks, and/or the like). In this way, data can be propagated from one device of the plurality of devices 102-124 to some or all of the plurality of devices 102-124 as one or more of the operations described herein are performed.

With continued reference to FIG. 1, the plurality of devices 102-124 can be analyzed to determine one or more dependencies. For example, one or more of the plurality of devices 102-124 (referred to as an “analyzing device”) or a device separate from the plurality of devices 102-124 can analyze the plurality of devices 102-124 to determine the one or more dependencies. In examples, the one or more dependencies can be analyzed based at least on the analyzing device traversing the plurality of devices 102-124. When traversing the plurality of devices 102-124, the analyzing device can implement a breadth-first search (BFS) and/or other similar searches to communicate with each device of the plurality of devices 102-124 and the analyzing device can determine a dependency graph based at least on the communications with each device of the plurality of devices 102-124. In some embodiments, the dependency graph can be the same as, or similar to, the representation of the plurality of devices 102-124 shown in FIG. 1.

As shown in FIG. 1, the dependency graph can be represented as a directed acyclic graph such that each device of the plurality of devices 102-124 involved in the generation of the dependency graph is associated with (e.g., corresponds to) a vertex in the dependency graph. Each device of the plurality of devices 102-124 representing a vertex may be associated with edges that connect each vertex to one or more different vertices. As illustrated, the edges include arrows going in one direction. Each edge can represent a dependency, with the line extending from a first device of the plurality of devices 102-124 toward a different device of the plurality of devices 102-124 that the first device depends on. In one example, device A 102 is illustrated as dependent on device D 108, device F 112, and device G 114. In some embodiments, the analyzing device (discussed above) can generate one or more orderings of vertices based at least on the analyzing device determining the dependency graph (e.g., the dependency graph represented by the connections between the plurality of devices 102-124 of FIG. 1). For example, when performing a BFS during execution of a topological sort algorithm, the analyzing device can communicate with each device involved in the BFS (e.g., each device of the plurality of devices 102-124) and the analyzing device can generate one or more orderings (sometimes referred to as topological orderings) of the plurality of devices 102-124 based at least on the analyzing device communicating with each device involved in the BFS. In one illustrative example, the analyzing device can generate a first ordering (e.g., a first topological ordering) as follows: {device A 102, device B 104, device C 106, device D 108, device E 110, device F 112, device G 114, device I 118, device J 120, device K 122, and device L 124}. In another illustrative example, the analyzing device can generate a second ordering as follows: {device A 102, device C 106, device B 104, device D 108, device E 110, device F 112, device G 114, device I 118, device J 120, device K 122, and device L 124}. In yet another illustrative example, the analyzing device can generate a third ordering as follows: {device A 102, device D 108, device F 112, device C 106, device B 104, device E 110, device G 114, device I 118, device J 120, device K 122, and device L 124}. Each of the orderings generated by the analyzing device can be based at least on one or more levels (e.g., level 0, level 1, level 2, and/or the like), where each level represents a number of vertices that are traversed to reach one or more different vertices. It will be understood that devices associated with a given level will not be dependent on the performance of operations by other devices of that level. It will also be understood that the analyzing device can generate any ordering based at least on the analyzing device performing a BFS using the dependency graph illustrated by FIG. 1.

In some embodiments, the analyzing device can transmit data associated with an ordering as described herein to enable one or more devices of the plurality of devices 102-124 to perform operations in accordance with the ordering. For example, the analyzing device can transmit data associated with an ordering to each device, where the data associated with the ordering represents one or more of the plurality of devices 102-124 that a given device is dependent on when performing operations corresponding to the given device. In examples, the analyzing device can transmit data associated with the ordering to each device, where the data associated with the ordering represents one or more of the plurality of devices 102-124 that depend from a given device. In some embodiments, the analyzing device can transmit the data associated with the ordering to a package manager that monitors operation of each device of the plurality of devices 102-124. In some examples, the analyzing device can include (e.g., can be the same as, or similar to) a package manager. By virtue of implementing the techniques described herein, in examples, the operation of a package manager can be updated such that the package manager can initiate the performance of operations as corresponding dependencies are satisfied and not in accordance with a predetermined sequence, which can reduce the amount of time needed to perform all of the operations managed by the package manager.

In some embodiments, each device of the plurality of devices 102-124 can be configured to perform (or caused to perform) operations in accordance with the ordering. For example, each device of the plurality of devices 102-124 can receive the ordering (and/or corresponding portions thereof) from the analyzing device and determine whether one or more dependences specified by the ordering are satisfied during performance of the operations. In one illustrative example, when installing a package, a first device of the plurality of devices 102-124 can determine that installation of the package by the first device depends on successful installation of at least one package from at least one second device of the plurality of devices 102-124. In this example, the first device can be a terminal vertex that is located at the beginning of an inverse of the dependency graph used to determine the ordering. The first device can then determine that messages were or were not received from the at least one second device indicating that dependent packages were installed by the at least one second device of the plurality of devices 102-124 before installation of the corresponding package by the first device. In this example, the first device can perform operations corresponding to the first device based at least on the first device determining that messages were received by each device of the at least one second device.

In one illustrative example, a program can be installed based at least the plurality of devices 102-124 performing one or more operations in accordance with the ordering. In this example, each device of the plurality of devices 102-124 involved in the installation can receive a message including an instruction to start installation of packages on which the program depends and/or data associated with each package. The instruction to start installation may be associated with (e.g., include) the ordering determined by the analyzing device. In response to receiving the instruction to start installation of the program, each device of the plurality of devices 102-124 can determine whether to perform the one or more operations associated with (e.g., assigned to) each device based at least on each device of the plurality of devices 102-124 determining whether corresponding dependencies associated with the operations to be performed are satisfied. When a given device of the plurality of devices 102-124 determines that the dependencies are satisfied (e.g., that one or more other devices of the plurality of devices 102-124 have successfully completed corresponding operations, that a given device of the plurality of devices 102-124 is not associated with any dependencies, and/or the like), the given device can then perform operations associated with (e.g., assigned to) the given device.

In this illustrative example, and with reference to the first ordering described above, a first set of devices can determine that the operations the first set of devices are assigned to perform are not associated with any dependencies. In this case, the first set of devices can include: device G 114, device I 118, device J 120, device K 122, and device L 124. Each device of the first set of devices can then perform the operations assigned to each corresponding device in parallel. More specifically, GPU 2 can cause device G 114 to perform the operation(s) corresponding to device G 114, while GPU 3 causes device I 118, device J 120, device K 122, device L 124 to perform the operation(s) corresponding to the respective devices. In response to each device of the first set of devices performing the operation(s) assigned to the respective devices, each device of the first set of devices can transmit a message to one or more other devices of the plurality of devices 102-124 indicating that the operation(s) were performed. In one example, in response to device I 118 performing the assigned operations, device I 118 can then generate and transmit a message to device E 110 indicating that the operation(s) assigned to device I 118 were successfully performed by device I 118. In this example, device I 118 can generate and transmit the message to device E 110 based at least on device I 118 determining that the operations associated with device E 110 depend on the successful completion of the operations assigned to device I 118. In some examples, the performance of operations by devices of the plurality of devices 102-124 can be iteratively performed as each device of the plurality of devices 102-124 determines that the corresponding dependencies were satisfied. Installation of the program can conclude when each device of the plurality of devices 102-124 completes the corresponding operation(s) that were assigned to each device. In other examples, as when coordinating the performance of operations across devices using a package manager, the performance of operations corresponding to devices with unsatisfied dependencies can be deferred (e.g., not queued, blocked, and/or the like) by the package manager until the package manager determines that all of the dependencies involved in performing the given operations are satisfied.

While performance of the one or more operations is described herein with respect to installation of a program, it will be understood that the present disclosure is not so limited. For example, in the case where a program is being complied, each device of the plurality of devices 102-124 can be assigned one or more corresponding operations involved in the compilation of the program. Similar to as described above, each device of the plurality of devices 102-124 can perform the assigned operation(s) based at least on each device of the plurality of devices 102-124 determining that the corresponding dependencies are satisfied. In this way, portions of the program can be compiled in parallel rather than in sequence. This, in turn, can reduce the downtime experienced by respective devices of the plurality of devices 102-124 that is typical of program compilation using non-parallel processing systems.

In another example, each device of the plurality of devices 102-124 can be associated with dependencies that indicate which other devices of the plurality of devices 102-124 can be reached by the given device. In this example, where the flow of data is being analyzed between each device of the plurality of devices 102-124, the dependencies of a given device can be analyzed (e.g., when performing a strongly connected component reachability query) to determine whether or not one or more other devices of the plurality of devices 102-124 are reachable (e.g., whether the device being analyzed can communicate with the one or more other devices of the plurality of devices 102-124).

In yet another example, each device of the plurality of devices 102-124 can be associated with devices involved in a power grid. For example, each device of the plurality of devices 102-124 can be associated with one or more of generators, transformers, transmission lines, and/or distribution lines. In these examples, where the cut sets within a power grid comprising the plurality of devices 102-124 is being analyzed, the dependencies of a given device can be analyzed to determine whether or not one or more other devices of the plurality of devices 102-124 are reachable (e.g., whether the device being analyzed can communicate electrically with the one or more other devices of the plurality of devices 102-124). This analysis can result in a set of cut sets (e.g., k-cut sets, minimum cut sets, and/or the like) that can be used to determine the reliability of the power grid.

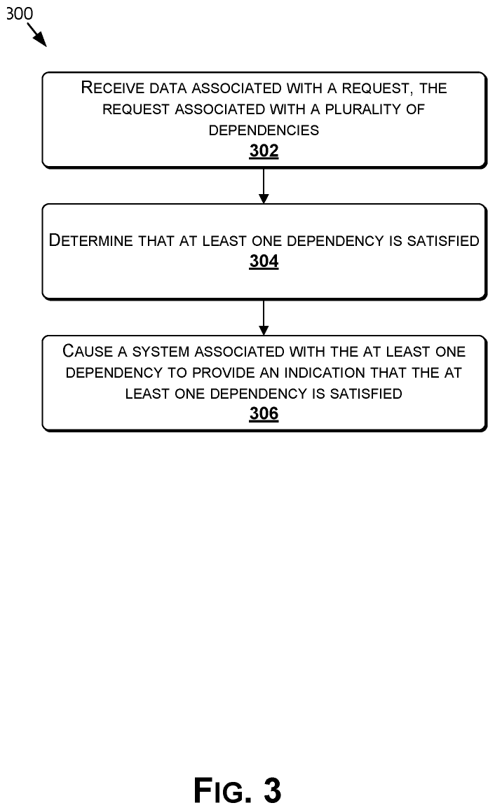

Now referring to FIG. 3, each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the environment 100 of FIG. 1. However, this method may additionally or alternatively be executed by any one system, or any combination of systems, including, but not limited to, those described herein.

FIG. 3 is a flow diagram showing a method 300 for parallel and distributed topological sorting, in accordance with some embodiments of the present disclosure. The method 300 can be implemented by one or more systems, devices, or components discussed herein.

The method 300, at block 302, includes receiving data associated with a request. For example, one or more devices (e.g., devices that are the same as, or similar to, the plurality of devices 102-124 of FIG. 1) can receive the data associated with the request. In examples, the request can include a request to install a program, a request to compile a program, a request to schedule one or more tasks (e.g., operations and/or the like) to be executed by one or more devices, and/or the like. In some embodiments, the request is associated with a plurality of dependencies. For example, the request can be associated with (e.g., specify) a plurality of dependencies to be satisfied before the request can be completed. In one illustrative example, with respect to requests involving installing a program, installation of the program can be associated with multiple dependencies, each dependency corresponding to successful installation of a package necessary to execute the program. In another illustrative example, with respect to requests involving compilation of programs, the compilation can be associated with multiple dependencies such as the downloading libraries etc., prior to the initiation of the compilation.

In some embodiments, the one or more devices can determine the one or more dependencies. For example, the one or more devices can analyze the request and the one or more devices can determine the one or more dependencies based at least on analyzing the request. In one example, where the request specifies the one or more dependencies, the one or more devices can perform a BFS based at least on the one or more dependencies to generate a dependency graph. In this example, the one or more devices can then assign the one or more dependencies to respective devices of the one or more devices based at least on analyzing the request. In examples, by assigning the one or more dependencies, the one or more devices can assign operations to the one or more devices to be performed once the dependencies for a given device are satisfied. In the context of parallel computing environments (see FIG. 2), the one or more devices can be configured to perform the one or more operations in parallel with the other devices as respective dependencies (if any) are satisfied by other devices.

The method 300, at block 304, includes determining that at least one dependency is satisfied. In some embodiments, where the request is associated with at least a first dependency and a second dependency, the one or more devices can determine whether the first and/or the second dependency are satisfied. For example, a first device can be assigned a first dependency, and a second device can be assigned a second dependency (similar to device G 114 and device D 108, respectively, of FIG. 1). In this example, the first dependency can be associated with performance of one or more operations (e.g., during installation of a program, etc.) and the second dependency can be associated with satisfaction of the first dependency and one or more different operations (e.g., during installation of the program). The first device can determine whether the first dependency is satisfied based at least on the first device determining whether the operations associated with the first dependency were successfully executed by the first device. In examples, where the first device determines that the first dependency is not satisfied (e.g., that the operations were unsuccessfully executed, that the operations have yet to be initiated, and/or the like), the first device can forgo providing the indication (e.g., not provide and/or transmit the indication to one or more other devices) that first dependency is satisfied. In these examples, the second device can forgo performing the one or more operations (e.g., wait to perform the one or more operations) assigned to the second device until the second device determines that the first dependency is satisfied. It will be understood that dependencies can be associated with different types of operations depending on the request. For example, when compiling a program, a dependency can be associated with the successful translation of source code into machine-readable code (e.g., by a given device). In another example, when determining whether one or more devices can be reached (e.g., for direct or indirect communication of data, messages, etc.) by a given device, the dependencies of a given device can be associated with whether or not one or more other devices can establish communication connections with the given device.

The method 300, at block 306, includes causing a system associated with the at least one dependency to provide an indication that the at least one dependency is satisfied. In some embodiments, and with continued reference to the first and second device discussed above, the first device can indicate to the second device that the dependency associated with the first device is satisfied. For example, the first device can determine that the operations associated with the first dependency are satisfied (e.g., have been successfully executed) and the first device can generate and transmit a message to the second device, the message including the indication that the operations associated with the first dependency are satisfied.

In some embodiments, the second device can determine whether the dependencies associated with the second device are satisfied based at least on the second device receiving the indication that the at least one dependency is satisfied. For example, the second device can compare the indication that the first dependency was satisfied to the second dependency. In this example, the second dependency can indicate one or more preconditions to be satisfied before the one or more operations assigned to the second device can be performed. In examples, where the second dependency indicates that only satisfaction of the first dependency is a precondition to the performance of the operations assigned to the second device, the second device can then cause the one or more operations assigned to the second device to be performed. In some examples, where the second dependency indicates that satisfaction of the first dependency and a third dependency is a precondition to the performance of the operations assigned to the second device, the second device can forgo causing the one or more operations to be performed. In these examples, dependencies associated with the second device can include the satisfaction of dependencies by the first device or the third device (e.g., successful execution of operations by each device, respectively) and/or satisfaction of one or more dependencies involving the performance of operations by the second device (e.g., the successful execution of operations by the second device).

In examples, the second device can determine that the third dependency is associated with a third device (e.g., similar to device J 120 of FIG. 1). In these examples, the second device can determine whether the dependencies associated with the second device are satisfied based at least on the second device receiving the indication that the at least one dependency is satisfied from both the first device and the third device. In one illustrative example, the second device can receive an indication from the first device that the first dependency is satisfied, and the second device can not receive an indication from the third device that the third dependency is satisfied. This can be because, for example, the third device is waiting for confirmation that its dependencies are satisfied, the third device is not in communication with the second device, and/or the like. The second device can then receive the indication from the third device that the third dependency is satisfied and determine that the precondition associated with the second dependency is satisfied based at least on the second device receiving the indication that the third dependency is satisfied. In some embodiments, the second device can execute the operation assigned to the second device based at least on the second device determining that the first dependency and the third dependency are satisfied.

In some embodiments, one or more devices can determine that the plurality of dependencies associated with the request are satisfied. For example, the one or more devices (e.g., similar to device A 102, device B 104, or device C 106 of FIG. 1) can determine that the plurality of dependencies associated with the request are satisfied based at least on the one or more devices determining that the operations assigned to the one or more devices were successfully executed and that no other devices have dependencies involving the successful execution of the operations assigned to the one or more devices. In examples where there are multiple devices that successfully executed their assigned operations, the multiple devices can send indications to the other of the devices indicating that the operations were successfully executed and that the request can be satisfied. In some examples, where there is a single device that successfully executed the operations assigned to the device based at least on the single device receiving the indications that the corresponding dependencies were satisfied, the single device can determine that the plurality of dependencies associated with the request were satisfied. In these examples, one or more of the devices can then cause the request to be satisfied (e.g., for the program to be installed, for the program to be compiled, etc.) based at least on the determination that the dependencies associated with the request were satisfied.

In some embodiments, one or more of the first device, the second device, and the third device can be combined with another of the first device, the second device, or the third device. In one illustrative example, the first device, the second device, and the third device can include cores of a CPU or GPU and/or software modules that are implemented by a CPU or GPU (e.g., by one or more cores of a CPU or GPU) from among a plurality of CPUs or GPUs (see, e.g., FIG. 2). In this example, where the second device and the third device are implemented by the same CPU or GPU, the indication provided from the third device to the second device indicating that the third dependency is satisfied can be provided and received by the same system. In examples, where the second device and the third device are implemented by different CPUs or GPUs, the indication provided from the third device to the second device indicating that the third dependency is satisfied can be provided and received by different systems. In these examples, the indication can be provided via communication channels established between the different systems (in this case, different CPUs or GPUs) as described herein. In some embodiments, these communication channels can be associated with an all-to-all network, a butterfly network, and/or the like.

### Example Computing Device

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof. In some embodiments, the computing device 400 can be implemented as one or more devices of FIG. 1 (e.g., one or more of the plurality of devices 102-124 of FIG. 1). Additionally, or alternatively, one or more of the components of the computing device 400 can be included in one or more of the devices of FIG. 1.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

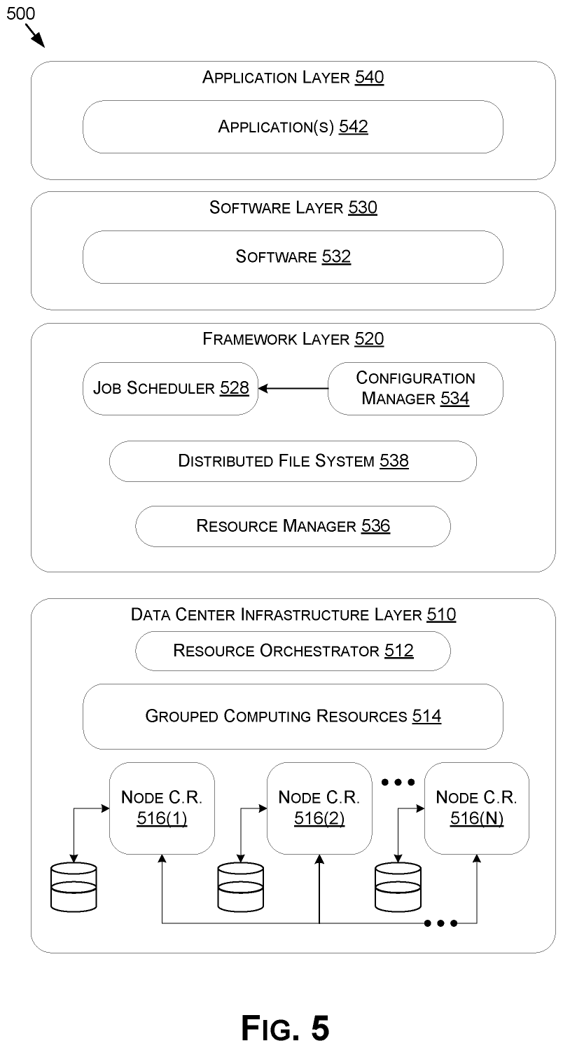

FIG. 5 illustrates an example data center 500 that may be used in at least one embodiments of the present disclosure. The data center 500 may include a data center infrastructure layer 510, a framework layer 520, a software layer 530, and/or an application layer 540. In some embodiments, one or more of the components of the data center 500 can be included in one or more of the devices of FIG. 1. Additionally, or alternatively, one or more of the devices of FIG. 1 can be included in (e.g., installed in, implemented by, and/or the like) the data center 500.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive data associated with a request to perform one or more processing operations using a graphics processing unit (GPU) comprising a plurality of cores, the request associated with a plurality of dependencies comprising a first dependency and a second dependency;
cause the plurality of cores involved in processing the request to perform the one or more processing operations in parallel based at least in part on a topological ordering associated with the processing operations;
determine that a first dependency of the set of dependencies is satisfied by a core of the plurality of cores in the GPU; and
cause the core associated with the first dependency to provide an indication that the first dependency is satisfied to a core associated with a second dependency.

2. The one or more processors of claim 1, wherein, when determining the first dependency is satisfied, the one or more circuits are to:
determine that one or more operations associated with the first dependency were executed by the one or more circuits, and that execution of the one or more operations was successful.

3. The one or more processors of claim 1, wherein the one or more circuits are to:
determine that a precondition associated with the second dependency is not satisfied; and
forgo satisfying the second dependency based at least on determining that the precondition associated with the second dependency is not satisfied.

4. The one or more processors of claim 3, wherein the precondition associated with the second dependency is further associated with satisfaction of the first dependency and a third dependency.

5. The one or more processors of claim 3, wherein the one or more circuits are to:
receive an indication that a third dependency is satisfied after forgoing satisfying the second dependency;
determine that the precondition associated with the second dependency is satisfied based on receiving the indication that the third dependency is satisfied; and
execute one or more operations associated with the second dependency based at least on determining that the precondition associated with the second dependency is satisfied.

6. The one or more processors of claim 5, wherein, when receiving the indication that the third dependency is satisfied, the one or more circuits are to:
receive the indication that the third dependency is satisfied from a core that is the same as the core corresponding to the second dependency.

7. The one or more processors of claim 5, wherein, when receiving the indication that the third dependency is satisfied, the one or more circuits are to:
receive the indication that the third dependency is satisfied from a core that is different from the core corresponding to the second dependency.

8. The one or more processors of claim 5, wherein the one or more circuits are to:
communicate each indication to respective cores in accordance with a predetermined network architecture.

9. The one or more processors of claim 8, wherein the predetermined network architecture is associated with a butterfly network.

10. The one or more processors of claim 5, wherein the second dependency is a precondition to the request, and
wherein the one or more circuits are to:
determine that the plurality of dependencies associated with the request are satisfied based at least on executing the one or more operations associated with the second dependency; and
satisfy the request based at least on determining that the plurality of dependencies associated with the request are satisfied.

11. The one or more processors of claim 1, wherein the one or more circuits is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing large language models (LLMs);
a system implementing vision language models (VLMs);
a system for hosting one or more real-time streaming applications;
a system for performing light transport simulation;
a system for performing collaborative content creation for 3D assets; or
a system implemented at least partially using cloud computing resources.

12. A system comprising:
one or more processors to perform operations comprising:
receiving data associated with a request to perform one or more processing operations, the request associated with a plurality of dependencies, the plurality of dependencies comprising a first dependency and a second dependency;
causing a plurality of systems in a distributed computing environment involved in processing the request to perform the one or more processing operations in parallel based at least in part on a topological ordering associated with the processing operations;
determining that a first dependency of the set of dependencies is satisfied by a system of the plurality of systems in the distributed computing environment; and
causing the system associated with the first dependency to provide an indication that the first dependency is satisfied to a system associated with a second dependency.

13. The system of claim 12, wherein, when determining that the first dependency is satisfied, the one or more processors perform the operation of:
determining that one or more operations associated with the first dependency were executed by the one or more processors, and that the execution of the one or more operations was successful.

14. The system of claim 12, wherein the one or more processors perform the operation of:
determining that a precondition associated with the second dependency is not satisfied; and
forgoing satisfying the second dependency based at least on determining that the precondition associated with the second dependency is not satisfied.

15. The system of claim 12, wherein the precondition associated with the second dependency is further associated with satisfaction of the first dependency and a third dependency.

16. The system of claim 14, wherein the one or more processors perform the operations of:
receiving an indication that a third dependency is satisfied after forgoing satisfying the second dependency;
determining that the precondition associated with the second dependency is satisfied based on receiving the indication that the third dependency is satisfied; and
executing one or more operations associated with the second dependency based at least on determining that the precondition associated with the second dependency is satisfied.

17. The system of claim 16, wherein, when receiving the indication that the third dependency is satisfied, the one or more processors perform the operation of:
receiving the indication that the third dependency is satisfied from a system that is the same as the system corresponding to the second dependency.

18. The system of claim 16, wherein, when receiving the indication that the third dependency is satisfied, wherein the one or more processors perform the operation of:
receiving the indication that the third dependency is satisfied from a system that is different from the system corresponding to the second dependency.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

20. A method comprising:
receiving data associated with a request to perform one or more processing operations, the request associated with a plurality of dependencies, the plurality of dependencies comprising a first dependency and a second dependency;
causing a plurality of systems in a distributed computing environment involved in processing the request to perform the one or more processing operations in parallel based at least in part on a topological ordering associated with the processing operations;
determining that a first dependency of the set of dependencies is satisfied by a system of the plurality of systems in the distributed computing environment; and
causing the system associated with the first dependency to provide an indication that the first dependency is satisfied to a system associated with a second dependency.
